(19) United States
(12) Patent Application Publication
(10) Pub. No.: US 2025/0022147 A1
(43) Pub. Date: Jan. 16, 2025

(54) SPORTS SIMULATION SYSTEMS AND METHODS

(71) Applicant: Chip Caddie Inc., Beverly Hills, MI (US)

(72) Inventor: Timothy Diamond, Beverly Hills, MI (US)

(21) Appl. No.: 18/768,973

(22) Filed: Jul. 10, 2024

Related U.S. Application Data
(60) Provisional application No. 63/525,851, filed on Jul. 10, 2023.

(51) Int. Cl. G06T 7/246; G06T 7/80; G06V 20/40; H04N 9/31

(52) U.S. Cl. CPC G06T 7/248; G06T 7/80; H04N 9/3179; G06T 2207/10016; G06T 2207/20092; G06T 2207/30204; G06T 2207/30224; G06T 2207/30241; G06V 20/40

(57) ABSTRACT

A system may include a screen to be impacted by an object and to display a trajectory of the object, a projector to project the trajectory of the object on the screen, a mat positioned to have the object launched therefrom and toward the screen, and a camera positioned to capture one or more images of the mat and the screen. The system may include a processor in data communication with the camera and the projector and configured to execute a set of instructions to: receive a sequence of images from the camera, determine which of the sequence images represents an impact frame in which the object impacts the screen, determine the trajectory of the object based on the object location in the impact frame; and output a display signal to the projector to display a visual graphic on the screen based on the trajectory.

### CROSS-REFERENCED TO RELATED APPLICATION

This application claims priority to U.S. Provisional Application No. 63/525,851, which was filed on Jul. 10, 2023.

### BACKGROUND

Computer-based simulators for simulating the flight of objects are systems that use software and hardware to recreate the physics and dynamics of an object's flight in a virtual environment.

Many sports are based upon the movement of objects, such as balls, pucks, arrows, or darts, for achieving a goal. In a sports simulation system, a player propels a sports projectile such as a ball, puck, arrow, dart, etc. at a target image presented on a display screen. The motion of the sports projectile is detected and imaged and an extrapolation of the trajectory of the sports projectile is made. The extrapolated trajectory is then used to determine a result. The displayed image is updated to reflect the result to provide the player with visual feedback, such as to simulate a sports experience.

### SUMMARY

In some aspects, the techniques described herein relate to a system for computer generated sports simulation, including a screen configured to be impacted by an object and to display a trajectory of the object. A projector is configured to project the trajectory of the object on the screen. A mat is positioned to have the object launched therefrom and toward the screen. A camera is positioned to capture one or more images of the mat and the screen. A processor is in data communication with the camera and the projector. The processor is configured to execute a set of instructions to perform a method including: receive a sequence of images from the camera; determine a location of the object in each of the images in the sequence of images; determine which of the sequence images represents an impact frame in which the object impacts the screen; determine the trajectory of the object based on the object location in the impact frame; and output a display signal to the projector to display a visual graphic on the screen based on the trajectory.

In some aspects, the techniques described herein relate to a system, and the mat includes one or more markings to assist in calibration of the system.

In some aspects, the techniques described herein relate to a system, and the processor is configured to determine the trajectory of the object based on the time between the impact frame and an original frame.

In some aspects, the techniques described herein relate to a system, and the screen is rectangular and is oriented in a portrait orientation.

In some aspects, the techniques described herein relate to a system, and the processor is configured to detect a launch of the object from the mat toward the screen.

In some aspects, the techniques described herein relate to a system, and the image at the launch is an original frame, and the processor is configured to determine the trajectory of the object based on the time between the impact frame and the original frame.

In some aspects, the techniques described herein relate to a system, and the processor is configured to determine the impact frame, by comparing pixels in each of the sequence images to corresponding pixels in the original frame.

In some aspects, the techniques described herein relate to a system, and the processor is configured to threshold a pixel difference in the pixel comparison such that any differences above a threshold value are turned to white pixels, and any values below a threshold value are turned to black pixels, to summarize all of the white pixels, to graph the number of white pixels against time, and to determine the impact frame from when there is a spike in the graph of the number of white pixels against time.

In some aspects, the techniques described herein relate to a system, and the mat includes one or more markings to assist in calibration of the system.

In some aspects, the techniques described herein relate to a system, and the screen is rectangular and is oriented in a portrait orientation.

In some aspects, the techniques described herein relate to a system, and the system is configured to be calibrated by a user orienting the camera to capture images of the mat and the screen and determining the locations of known markings on at least one of the mat, the screen, and the frame.

In some aspects, the techniques described herein relate to a system, and the locations of the known markings are determined by receiving input from the user.

In some aspects, the techniques described herein relate to a system, and the known markings include two balls placed on marked areas on the mat.

In some aspects, the techniques described herein relate to a system, and the known markings include lower right and left corners of the frame.

In some aspects, the techniques described herein relate to a method for simulating a sport, including detecting a launch of an object from a mat toward a screen. The method includes capturing, with a camera, a sequence of images of the mat and the screen associated with the object being launched toward the screen. The method includes comparing pixels in a location in each of the sequence of images to pixels in a corresponding location in an original frame at the time the object was launched. The method includes determining which of the sequence images represents an impact frame in which the object impacts the screen. The method includes determining a trajectory of the object based on the object location in the impact frame. The method includes displaying the trajectory of the object on the screen.

In some aspects, the techniques described herein relate to a method, and the determining the trajectory is based on the amount of time between the original frame and the impact frame.

In some aspects, the techniques described herein relate to a method, including: thresholding a pixel difference in the pixel comparison such that any differences above a threshold value are turned to white pixels, and any values below the threshold value are turned to black pixels; summarizing all of the white pixels; graphing the number of white pixels against time; and determining the impact frame from when there is a spike in the graph of the number of white pixels against time.

In some aspects, the techniques described herein relate to a method, including: calibrating simulation equipment based on user identification of markings on at least one of the mat, the screen, and the frame.

In some aspects, the techniques described herein relate to a method, including: calibrating simulation equipment based on user identification of known markings on at least one of the mat, the screen, and the frame.

In some aspects, the techniques described herein relate to a method, and the known markings include two balls placed on marked areas on the mat.

These and other features may be best understood from the following specification and drawings, the following of which is a brief description.

### BRIEF DESCRIPTION OF THE DRAWINGS

FIG. 1 schematically illustrates an example system for computer generated sports simulation.

FIG. 2 illustrates an example calibration of the system of FIG. 1.

FIG. 3 illustrates a flowchart of an example impact detection algorithm.

FIG. 4 illustrates an example pixel difference for a sequence of frames.

FIG. 5 illustrates a graph of pixel counts against time.

FIG. 6 illustrates a sequence of frames having different object locations.

FIG. 7 illustrates an example impact frame.

FIG. 8A illustrates an example calculation for velocity and trajectory of a putt.

FIG. 8B illustrates an example sequence of frames of a putt.

### DETAILED DESCRIPTION

This application relates generally to computer-based simulators for simulating the flight of objects. In some implementations, the objects may be balls, pucks, arrows, or darts in various types of sports, such as sports in which an object is struck or thrown by a player.

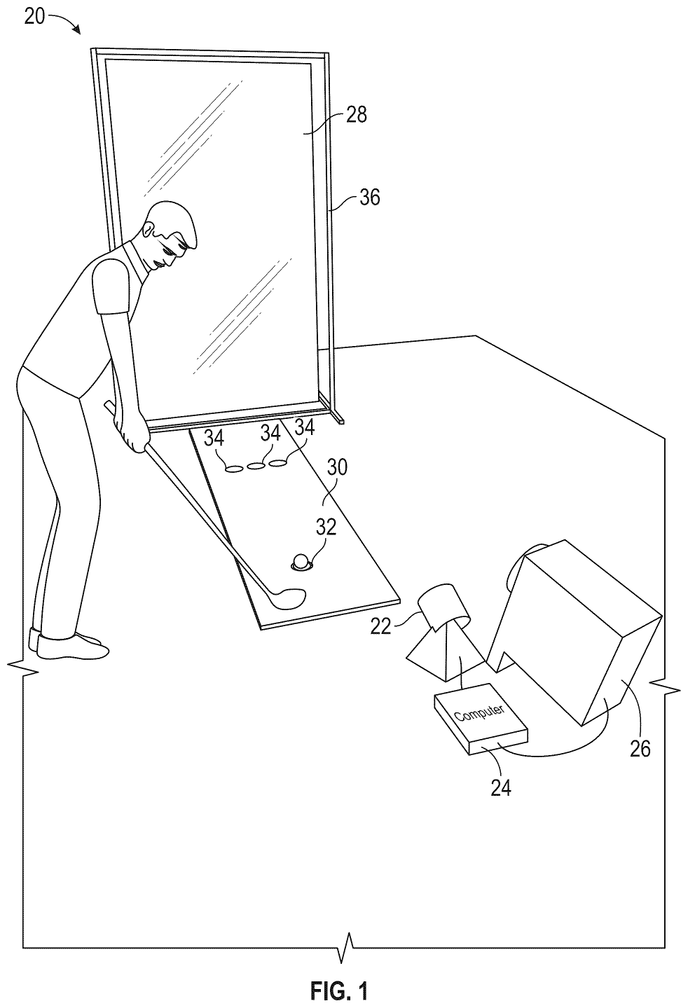

FIG. 1 schematically illustrates an example system for computer generated sports simulation 20 including a camera 22 for capturing images of an object 23. In some implementations, as shown, the object 23 is a ball, and the system 20 is a sports simulation system. In some implementations, the system 20 is a golf simulation system.

In some implementations, the camera 22 is a color or monochrome camera. A computer 24 receives one or more images captured by the camera 22 and uses novel image processing techniques to calculate the ball trajectory using a ball detection algorithm in conjunction with an impact tracking algorithm (line crossing algorithm for putting). The computer 24 includes processing circuitry that supports operation of the system 20. The computer 24 is operatively connected to memory (which may include any one or combination of volatile memory elements (e.g., random access memory (RAM, such as DRAM, SRAM, SDRAM, VRAM, etc.)) and/or nonvolatile memory elements (e.g., ROM, hard drive, tape, CD-ROM, etc.). The computer 24 may also be operatively connected to a Graphics Processing Unit (“GPU”) and/or I/O peripherals such as network interfaces and physical input devices (trackpads, buttons, mice, etc.). The processing circuitry may include one or more microprocessors, microcontrollers, application specific integrated circuits (ASICs), or the like. The example computer 24 may be configured to perform near real-time calculation of a ball's flight trajectory and velocity.

The example computer 24 provides signals to a projector 26 to project images onto a screen 28, e.g., a virtual display of the ball 23 traveling to a target. In some implementations, as shown, the screen 28 may be rectangular and oriented in a portrait orientation. The projector 26 is oriented to project a video image on the screen 28 in response to signals from the computer 24. A marked mat 30 may be utilized and may include a marked starting area 32 for the ball 23. The example computer 24 is in data communication with the camera 22 and the projector 26. In some implementations, the mat 30 may be any material that provides a suitable golf hitting surface. The mat 30 may be rectangular in some examples. The screen 28 may be made of a material suitable to absorb impact from the ball or other object in some examples.

The example marked mat or hitting surface 30 is positioned such that a player hits the ball 23 into the screen 28. The example camera 22, computer 24, and projector 26 are positioned a lateral distance from, and a distance behind, the starting area 32. In some examples, the camera 22 is oriented such that it captures all points of interest for calibration (discussed below) while being as close as possible to the screen. In some examples, the camera 22 is positioned 1-3 feet laterally and 1-3 feet behind the marked area 32. In some examples, the camera 22 is positioned about 1.5 feet (±20%) laterally and about 1.5 feet (±20%) behind the marked area 32. In some examples, the camera 22 is oriented toward the center of the screen 28.

In some examples, the camera 22 is a USB camera and communicates over USB to the computer 24. In some examples, the camera 22 is oriented vertically (portrait as opposed to the landscape) so as to capture the vertically oriented projector screen. In some examples, the camera 22 includes an ⅓-inch OV4689 image sensor or similar sensor. In some examples, the camera 22 films at 260 frames per second (fps) at 640×480 resolution, 120 fps at 1280×720 resolution, and 60 fps at 1920×1080 resolution.

The mat 30 is marked to assist the user and system 20 during calibration and for ball placement before a shot. The mat 30 is of known length and width to the system 20. The user is expected to hit the ball from the marked starting area 32, such as a ball placement circle, which is marked. The example mat 30 provides additional markings 34 between the starting area 32 and the screen 28 to assist the user in placing the putting calibration ball, as discussed further below. The markings 32, 34 are at world-space location known to the system 20, which is what allows the system 20 to convert between the pixel space from images into world-space for ball trajectory calculation. In some examples, as shown, the markings 34 include a left marking, a central marking, and a right marking, and the central marking is aligned with the starting area 32.

The example system 20 may further include a projector frame 36 to hold the screen in place, as well as to assist in system calibration. Because the frame 36 is a known height and width to the system 20, when calibrated as discussed further below, the impact calculation algorithm can convert between pixel space of ball impact into world-space coordinate of ball impact, as discussed further below.

The projector 26 may be a standard projector that reads from an HDMI signal from the computer 24. The projector 26 may be oriented vertically so as to project a large image on the screen, which may also be oriented vertically. In some examples, this orientation maximizes the utilization of space in confined rooms.

While the system 20 is used for golf simulation in the illustrative example, the systems and methods described herein may be utilized for simulation of other sports, including but not limited to soccer, baseball, hockey, football, and softball.

The processing is triggered when a ball 23 has moved away from the defined starting area 32. After a shot is processed and calculated using the novel techniques, the shot information is then input into the simulation software running on the processing circuitry of the computer 24, which outputs a video signal to the projector 26 allowing the user to have a fully immersive sports simulation experience. In some examples, the system 20 may be utilized indoors in semi-confined spaces.

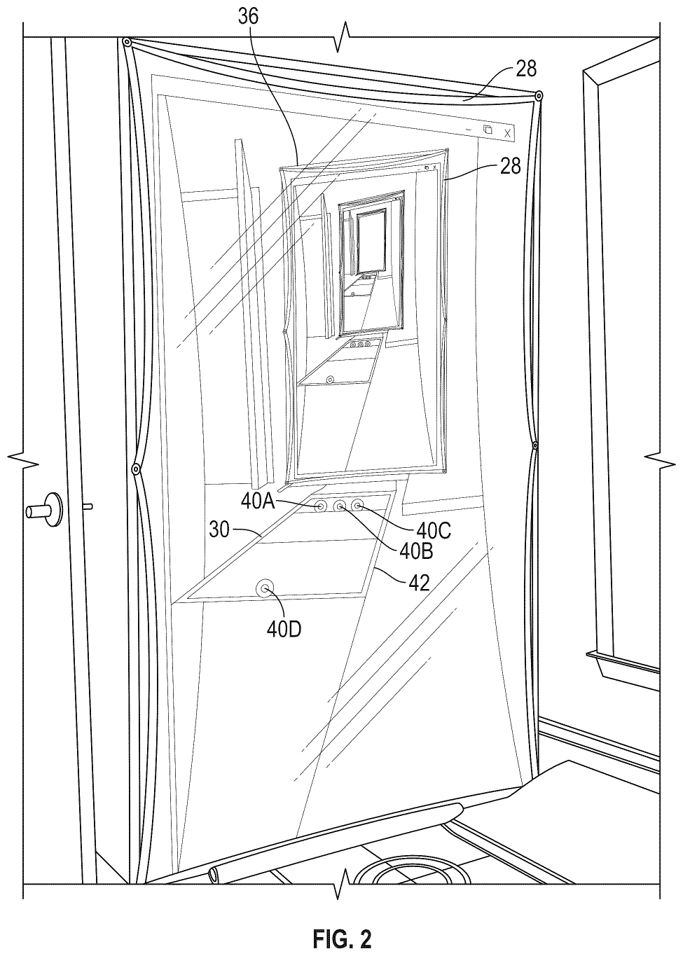

The aforementioned algorithms utilize a novel approach to system calibration, wherein the user is instructed to identify in a live camera feed specific points of interest in the imager. System calibration is performed using a novel technique, whereby the user is prompted to click on certain areas of interest via the camera feed to define in the system 20 where these objects exist at known world space locations relative to the ball start location. This approach relies on the fact that the integrated components are all of a known size and exist at known relative distances (frame, mat, markings, etc). Calibration can also be done in an automatic fashion, whereby the calibration image is fed into a computer vision object detector, instead of the user manually clicking on the calibration points. (see FIG. 2). In prior art systems, a launch monitor is calibrated using a standard checkerboard/QR code pattern to calibrate camera positioning to world space.

In an example calibration process, calibration mode is entered into by the user, such as by clicking a button in a simulation application on the computer 24. The user (or automated system) is then responsible for marking certain key areas of interest in the camera feed. In some examples, the areas of interest may be one or more points on the mat 30, the screen 28, and/or the frame 36. In some examples, these areas of interest include one or more of the following:
1. The 4 corners of the projector screen 28 or the frame 36 captured with the camera;
2. The centers of one or more calibration balls 40 (40A, 40B, 40C, 40D) placed on the mat 30 and captured by the camera. In some implementations, three calibration balls 40A, 40B, 40C (center, right, and left) are utilized along with the calibration ball 40D. The balls 40A, 40B, 40C may make up what is known as the Putting Calibration Line. In other implementations, only the center calibration ball 40B and the ball 40D may be utilized, and the lower right and left corners of the frame 36 may be utilized for lateral calibration. The Putting Calibration Line may then include the ball 40B and the lower right and left corners of the frame 36 in this example. As shown, the one or more balls 40A, 40B, 40C may be placed on the one or more markings 34, and the ball 40D may be placed on the marking 32;
3. The center of the one calibration shot ball 40D for shot triggering.
4. The putting area 42, which can either be manually calibrated, or inferred via an automatic algorithm based on the placement of 1, 2 and/or 3 from above.

In some implementations, the depth calibration can be obtained from the positions of balls 40B and 40D and the left and right calibration can be obtained from the lower right and left corners of the frame 36. The user may orient the camera 22 to capture one or more images of the mat 30, the screen 28, and the frame 36 in the same image, which may be displayed on the screen 28 during calibration.

The calibration methods disclosed herein allow for highly variable camera positioning, registering pixel locations of certain points of interest at known relative 3-dimensional locations, and accurate world space positioning for detected objects in the image.

An example impact detection process includes a novel technique calculating ball velocity and trajectory. Prior art ball tracking solutions exist on a standalone basis—i.e., they are not directly integrated into the other components of a simulator system, such as the hitting surface, projector screen, mat, and/or frame or housing. In prior art systems, launch monitors are purchased as individual units for later integration into any number of potential environments/configurations.

The system 20 utilizes integration of multiple components. As an integrated solution, values obtained by the system 20 during System Calibration that are of known world space positions relative to the ball start location and each other are used in arriving at a final calculated shot trajectory and velocity.

In an example impact detection process, the system 20 tracks the ball 23 over time in each grabbed frame. The impact frame is detected by using a novel “impact detection algorithm,” which is performed by subtracting the pixel values in a select portion of the captured image to the original frame before the ball was hit. When a large spike in these changes is detected, the system 20 determines that a ball 23 has struck the projector screen 28, as a splash on the screen causes differences in the captured image. Using the ball location at this impact frame in combination with the Calibration Values (see System Calibration), a full ball launch trajectory and velocity can be calculated using physics formulas.

In an implementation of the impact detection algorithm, the processing circuitry may receive a sequence of images from the camera, determine which of the sequence images represents an impact frame in which the object impacts the screen based on a spike in the pixel difference from the original frame, determine the object location in the impact frame, determine the trajectory of the object based on one or more of the object location in the impact frame and the time between the impact frame and the original frame and output a display signal to the projector to display a visual graphic on the screen based on the trajectory.

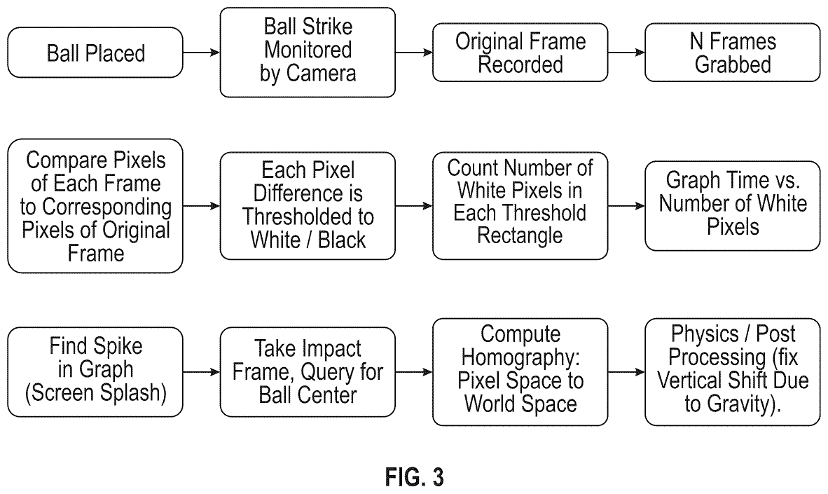

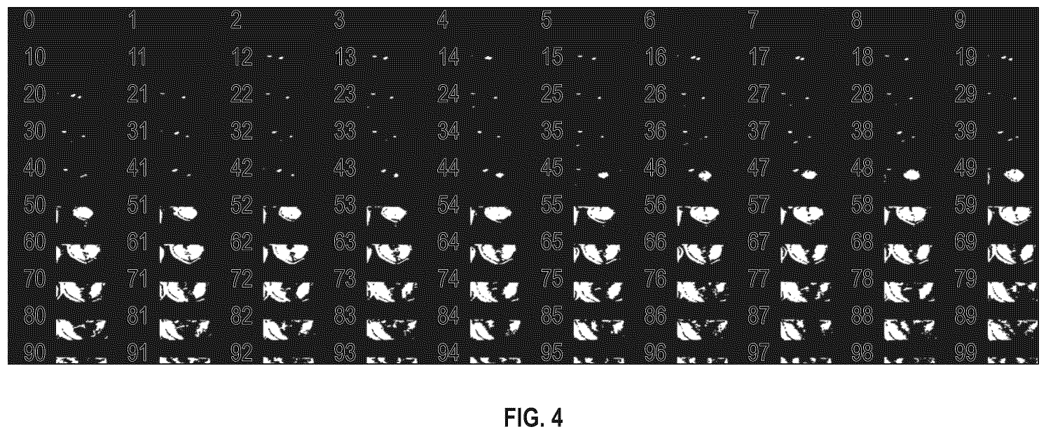

In some implementations, the impact detection algorithm may be as follows, as illustrated in the flowchart on FIG. 3). After a shot is triggered, the camera 22 immediately grabs N number of frames of video, where N is configurable by the designer. In some examples, N may be between 60-150, depending on the speed of the camera. The frame immediately before the shot is also recorded, which may be referred to as the original frame. For reference, the original frame is frame 0 in the FIG. 4 example. Each frame may be timestamped.

For each frame that was grabbed, the pixels of a select portion of the frame may be compared with the same portion in the original frame. In some implementations, this portion may be the projector screen 28 or the frame 36.

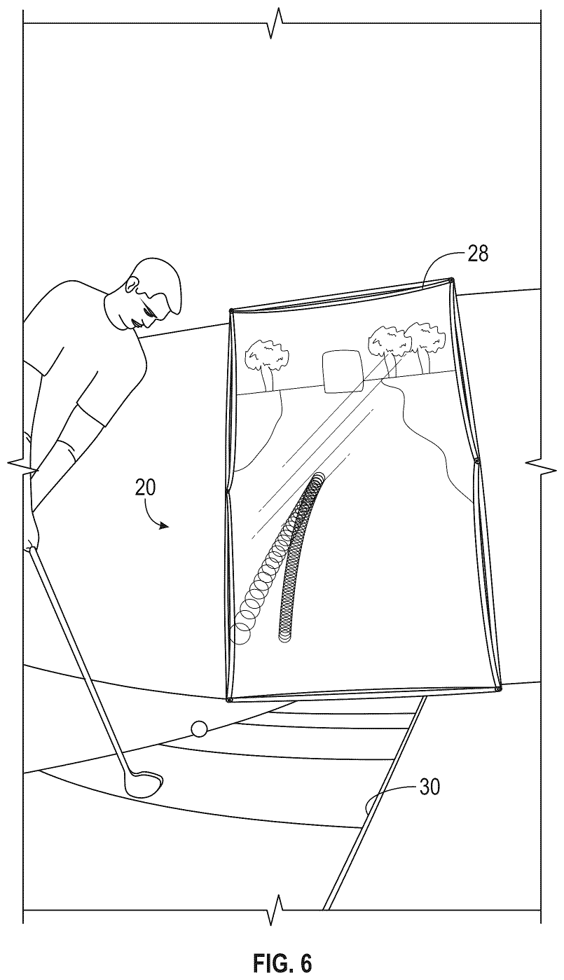

In other implementations, a ball detection algorithm may be performed. In some implementations, the system 20 may preprocess each frame to first mask out everything in the imagery besides the projector screen area and putting area using the Calibration Values (See System Calibration). In some implementations, a ball 23 can be detected by a variety of means, such as by color or by using a computer vision object detector. Each frame may have one or more “ball candidates.” Of these “ball candidates,” the most likely to be the ball may be selected based on a combination of heuristics. The ball's x and y pixel locations may be recorded. (See FIG. 6, where these locations are drawn on one frame over time) Each frame then has a ball location with x and y pixel coordinates. For each of these ball locations, a small rectangle whose center is the ball's location is created. All pixels outside of this rectangle are masked out.

For each frame's select portion, whether that be the projector screen 28, the frame 36, the ball location rectangle, or something else, a corresponding portion is selected from the original frame. The algorithm then subtracts the corresponding pixels in the frame's portion with the original frame's portion—creating a pixel difference for each frame's portion from the same portion in the original frame.

As shown in FIG. 4, there exists a pixel difference for each grabbed frame, which is the difference between that frame and the original frame. Each pixel difference is then thresholded, such that any differences above a threshold value are turned to white pixels, and any values below a threshold value are turned to black pixels. These rectangles may be called the threshold rectangles.

For each threshold rectangle, the algorithm does a sum of all white pixels. These may be called the white pixel counts.

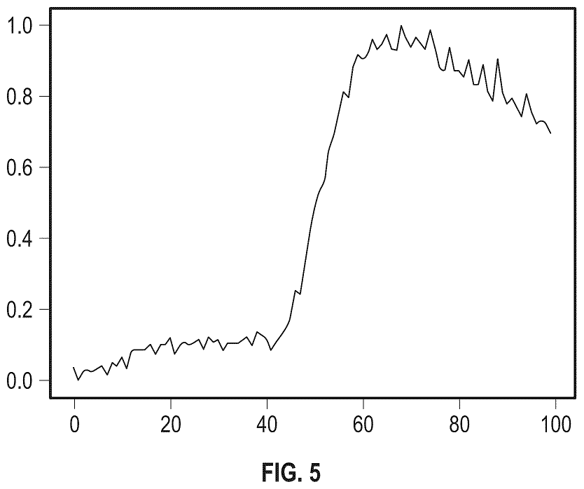

As shown in FIG. 5, the white pixel counts are graphed vs. time, since a timestamp is recorded when the frame was originally grabbed, and exists for each frame.

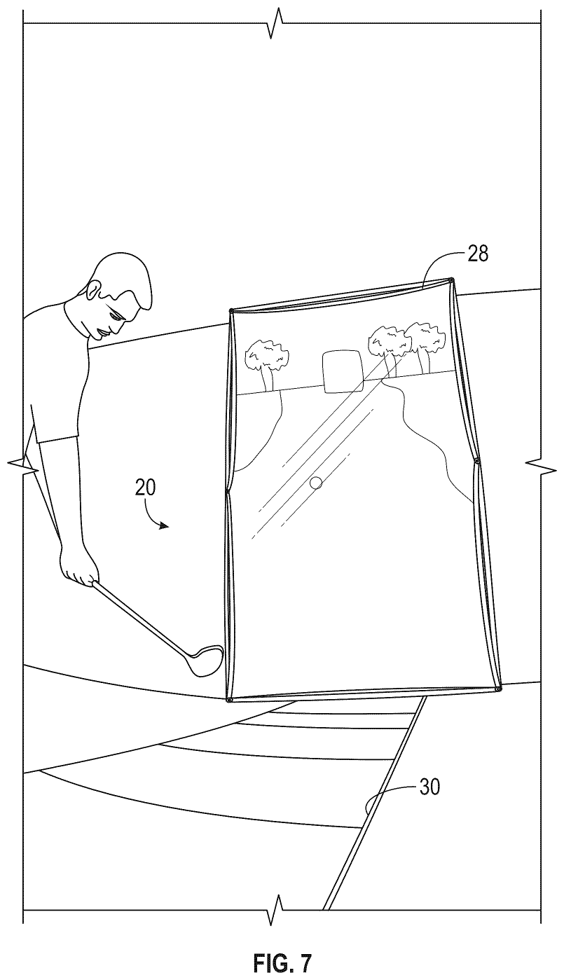

The algorithm looks for a spike in the graph of white pixel counts vs. time. The frame at which this spike occurs is called the impact frame, which represents when the ball 23 impacts the screen 28. (See FIG. 7 for Image). In the illustrative example, with reference to FIGS. 4 and 5, frame 45 is the frame that is above the threshold value of white pixels and would therefore be selected as the impact frame.

The algorithm then queries for the ball location from the impact frame. Now the system 20 has a ball pixel x and y location, a timestamp when the ball was struck, and a timestamp when the ball impacted the screen.

The algorithm takes the x and y pixel of the ball center in the Impact Frame, and using Homography and the Calibration Values (See System Calibration), converts the x and y pixel coordinate into a world space coordinate (x, y, z).

Using physics formulas, the system 20 can now derive the exact trajectory of the ball using world space start location, start timestamp, impact timestamp, and world space impact location, which can then be output to display the ball flight on the screen.

An example computerized method for tracking an object may include obtaining a sequence of images from a camera, determining an object location in each image, determining which of the images represents an Impact Frame in which the object impacts the screen, determining a trajectory of the object based on the object location in the Impact Frame, and causing rendering of a visual graphic based on the trajectory.

In some examples, the computer 24 may include a non-transitory, computer-readable storage medium having stored thereon logic that, when executed by one or more processors, causes performance of the operations disclosed herein.

The system may further utilize certain processes for putting detection. Putting shots are detected using a combination of the above technique, though impact location is calculated using a different method, because a putt does not hit the impact screen. At a high level, putting detection is performed by detecting the ball in each frame using methods from above. Once the ball's location crosses the Putting Calibration Line (see System Calibration), the system 20 converts the x and y pixel value of the ball into a value in world space. The putting velocity is then computed using the standard physics formulas.

A detailed summary is as follows:
1. Ball locations for each grabbed frame are computed in the same manner as above.
2. At each ball's location, the system 20 takes note of its x/y pixel location, and stop when the ball passes the pixel threshold of the Putting Calibration Line.
3. Each x,y pixel ball center is fit using a RANSAC method.
4. Since the system 20 knows the world space coordinate of the Putting Calibration Line, as well as the ball center pixel location at the Putting Calibration Line, the algorithm converts the x and y pixel coordinate of the ball at the Putting Calibration Line into a world space coordinate (x, y, z).

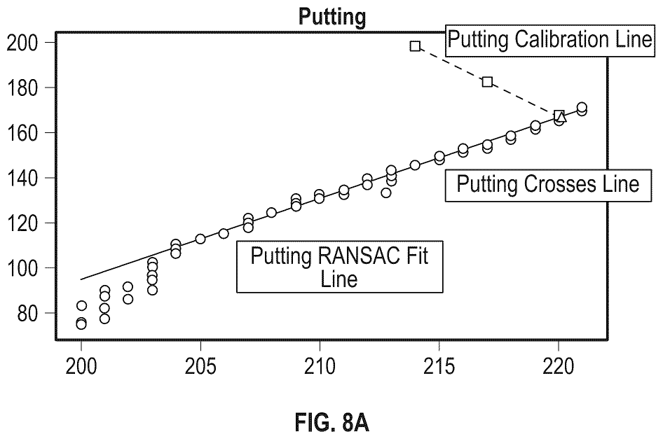

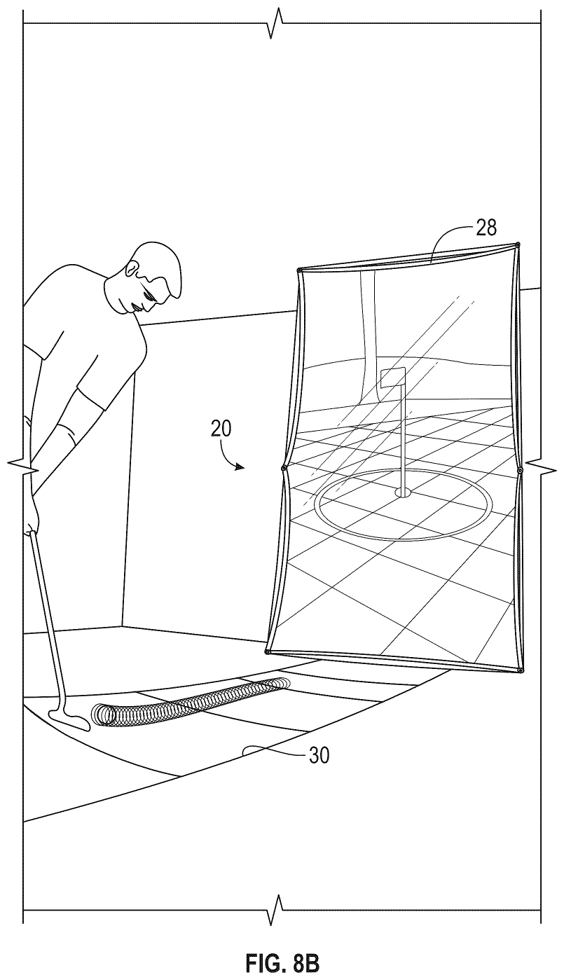

Using the timestamp when the ball was struck, the timestamp when the ball crosses the Putting Calibration Line, the RANSAC fit line of x,y ball centers, and the world space position at the Putting Calibration Line, standard physics formulas are used to compute the velocity and trajectory of the putt, which can then be output to be displayed on the screen. (See FIGS. 8A and 8B).

In some examples, the system 20 may be highly optimized for small spaces in a variety of ways. The system 20 uses a unique vertically oriented system, to be able to fit in almost any small room configurations. This is most apparent when considering the distance between the ball start location and impact scree. In some examples, the distance between the marked starting area 32 and the screen is 4-8 feet. The system 20 may be configured in such a way that even the shortest of chip shots will still impact the screen while in flight—allowing the user to truly aim for “landing spots” in the rendered image.

Additionally, the usage of lower cost hardware is enabled by the novel tracking algorithms described herein. The system may be fully integrated, which allows for the lower cost hardware to perform accurate tracking using knowledge of the positioning/size of the integrated components. In comparison to other launch monitor technologies, the system 20 may not use IR sensors, IR cameras, radar, or lidar to perform its computations in some examples. Additionally, the novel tracking algorithms may make stereo imaging techniques (multiple cameras) unnecessary, allowing for accurate tracking using a single camera. That is, multiple cameras may not be utilized in some examples.

An example system may be said to include a screen, a camera oriented toward the screen, a projector oriented toward the screen, a computer configured to: receive a sequence of images from the camera, determine an object location in each image, determine which of the images represents an Impact Frame in which the object impacts the screen, determine a trajectory of the object based on the object location in the Impact Frame, and output a display signal to the projector to display a visual graphic on the screen based on the trajectory.

An example system for computer generated sports simulation may be said to include a screen configured to be impacted by an object and to display a trajectory of the object. A projector is configured to project the trajectory of the object on the screen. A mat is positioned to have the object launched therefrom and toward the screen. A camera is positioned to capture one or more images of the mat and the screen. A processor is in data communication with the camera and the projector. The processor is configured to execute a set of instructions to perform a method including: receive a sequence of images from the camera; determine a location of the object in each of the images in the sequence of images; determine which of the sequence images represents an impact frame in which the object impacts the screen; determine the trajectory of the object based on the object location in the impact frame; and output a display signal to the projector to display a visual graphic on the screen based on the trajectory.

An example method for simulating a sport may be said to include detecting a launch of an object from a mat toward a screen, capturing, with a camera, a sequence of images of the mat and the screen associated with the object being launched toward the screen, comparing pixels in a location in each of the sequence of images to pixels in a corresponding location in an original frame at the time the object was launched, determining which of the sequence images represents an impact frame in which the object impacts the screen, determining a trajectory of the object based on the object location in the impact frame, and displaying the trajectory of the object on the screen.

Although the different examples are illustrated as having specific components, the examples of this disclosure are not limited to those particular combinations. It is possible to use some of the components or features from any of the embodiments in combination with features or components from any of the other embodiments.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A system for computer generated sports simulation, the system comprising:
a screen configured to be impacted by an object and to display a trajectory of the object;
a projector configured to project the trajectory of the object on the screen;
a mat positioned to have the object launched therefrom and toward the screen;
a camera positioned to capture one or more images of the mat and the screen; and
a processor in data communication with the camera and the projector, wherein the processor is configured to execute a set of instructions to perform a method comprising:
receive a sequence of images from the camera;
determine which of the sequence images represents an impact frame in which the object impacts the screen;
determine the trajectory of the object based on the object location in the impact frame; and
output a display signal to the projector to display a visual graphic on the screen based on the trajectory.

2. The system of claim 1, wherein the mat includes one or more markings to assist in calibration of the system.

3. The system of claim 1, wherein the processor is configured to determine the trajectory of the object based on the time between the impact frame and an original frame.

4. The system of claim 1, wherein the screen is rectangular and is oriented in a portrait orientation.

5. The system of claim 1, wherein the processor is configured to detect a launch of the object from the mat toward the screen.

6. The system of claim 5, wherein the image at the launch is an original frame, and the processor is configured to determine the trajectory of the object based on the time between the impact frame and the original frame.

7. The system of claim 6, wherein the processor is configured to determine the impact frame, by comparing pixels in each of the sequence images to corresponding pixels in the original frame.

8. The system of claim 7, wherein the processor is configured to threshold a pixel difference in the pixel comparison such that any differences above a threshold value are turned to white pixels, and any values below a threshold value are turned to black pixels, to summarize all of the white pixels, to graph the number of white pixels against time, and to determine the impact frame from when there is a spike in the graph of the number of white pixels against time.

9. The system of claim 8, wherein the mat includes one or more markings to assist in calibration of the system.

10. The system of claim 9, wherein the screen is rectangular and is oriented in a portrait orientation.

11. The system of claim 1, wherein the system is configured to be calibrated by a user orienting the camera to capture images of the mat and the screen and determining the locations of known markings on at least one of the mat, the screen, and the frame.

12. The system of claim 11, wherein the locations of the known markings are determined by receiving input from the user.

13. The system of claim 11, wherein the known markings include two balls placed on marked areas on the mat.

14. The system of claim 13, wherein the known markings include lower right and left corners of the frame.

15. A method for simulating a sport, comprising:
detecting a launch of an object from a mat toward a screen;
capturing, with a camera, a sequence of images of the mat and the screen associated with the object being launched toward the screen;
comparing pixels in a location in each of the sequence of images to pixels in a corresponding location in an original frame at the time the object was launched;
determining which of the sequence images represents an impact frame in which the object impacts the screen;
determining a trajectory of the object based on the object location in the impact frame; and
displaying the trajectory of the object on the screen.

16. The method of claim 15, wherein the determining the trajectory is based on the amount of time between the original frame and the impact frame.

17. The method of claim 16, comprising:
thresholding a pixel difference in the pixel comparison such that any differences above a threshold value are turned to white pixels, and any values below the threshold value are turned to black pixels;
summarizing all of the white pixels;
graphing the number of white pixels against time; and
determining the impact frame from when there is a spike in the graph of the number of white pixels against time.

18. The method of claim 17, comprising:
calibrating simulation equipment based on user identification of markings on at least one of the mat, the screen, and the frame.

19. The method of claim 15, comprising:
calibrating simulation equipment based on user identification of known markings on at least one of the mat, the screen, and the frame.

20. The method of claim 19, wherein the known markings include two balls placed on marked areas on the mat.
